(19) United States
(12) Patent Application Publication
(10) Pub. No.: US 2026/0029257 A1
(43) Pub. Date: Jan. 29, 2026

(54) ROTARY ENCODER, POSITION ADJUSTMENT MECHANISM, ADJUSTMENT TOOL AND POSITION ADJUSTMENT METHOD

(71) Applicant: MITUTOYO CORPORATION, Kanagawa (JP)

(72) Inventors: Shingo TAKEUCHI, Kanagawa (JP); Motohiro OSAKI, Tokyo (JP)

(73) Assignee: MITUTOYO CORPORATION, Kanagawa (JP)

(21) Appl. No.: 19/273,334

(22) Filed: Jul. 18, 2025

(30) Foreign Application Priority Data
Jul. 24, 2024 (JP) 2024-118921
Jul. 24, 2024 (JP) 2024-118923

(51) Int. Cl. G01D 11/16

(52) U.S. Cl. CPC G01D 11/16

(57) ABSTRACT

A rotary encoder includes a rotor, and a stator attached to a device body via a position adjustment mechanism. The position adjustment mechanism includes a hollow bolt having a hollow cylindrical portion as a shaft portion and an outer peripheral screw portion on an outer peripheral surface of the shaft portion that screws into an inner peripheral screw portion provided in a mounting hole of the stator, a nut that screws into the outer peripheral screw portion, and a fixing screw inserted into the hollow cylindrical portion and screwed into the device body. A diameter of the inner surface of the hollow cylindrical portion is set to a dimension that forms a gap between the inner surface and a screw portion of the fixing screw, allowing the stator, which is screwed into the hollow bolt, to move in a direction orthogonal to an axial direction of the fixing screw.

### CROSS-REFERENCE TO RELATED APPLICATION

This application is based upon and claims the benefit of priority of the prior Japanese Patent Application No. 2024-118921 filed on Jul. 24, 2024, and Japanese Patent Application No. 2024-118923 filed on Jul. 24, 2024, the entire contents of which are incorporated herein by reference.

### FIELD

A certain aspect of embodiments described herein relates to a rotary encoder, a position adjustment mechanism, an adjustment tool and a position adjustment method.

### BACKGROUND

Conventionally, devices are known that have a position adjustment target part that requires position adjustment relative to a base part. For example, International Publication No. 2023/054613 discloses a rotary encoder that includes a rotary scale having a scale pattern and a group of detection heads arranged opposite the rotary scale. The rotary scale is sometimes called a rotor. The group of detection heads is sometimes provided on a stator. In order for the rotary encoder to perform accurate measurements, it is necessary to adjust the relative positions of the rotor and stator arranged opposite to each other. The stator is sometimes attached to the device body of the device to which the rotary encoder is attached. In this case, the device body corresponds to the base part, and the stator corresponds to the part to be adjusted. The stator is required to be fixed to the device body or to be in a position adjustable state. In this case, if a position adjustment mechanism that can switch the stator between a fixed state and a position adjustable state and further adjust the position of the target object can be used, the position adjustment work will be easier.

Incidentally, tools that are designed to operate multiple fasteners are known (for example, Japanese Utility Model Laid-Open Publication No. S63-74278). The position adjustment mechanism described above also has multiple functions, so it is expected to have multiple fasteners such as screws and bolts.

### SUMMARY

In one aspect, the present invention aims to provide a rotary encoder capable of adjusting the position of a stator relative to the device body, and to provide a position adjustment mechanism capable of adjusting the position of a part to be adjusted relative to a base part, and an adjustment tool for use therewith.

According to an aspect of the present invention, there is provided a rotary encoder that is attached to a device having a device body and a rotation portion that is provided so as to be rotatable relative to the device body, the rotary encoder including: a rotor attached to the rotation portion; and a stator attached to the device body via a position adjustment mechanism, wherein the position adjustment mechanism includes a hollow bolt having a hollow cylindrical portion as a shaft portion and an outer peripheral screw portion on an outer peripheral surface of the shaft portion that screws into an inner peripheral screw portion provided in a mounting hole of the stator, a nut that screws into the outer peripheral screw portion, and a fixing screw that is inserted into the hollow cylindrical portion and screwed into the device body, and wherein a diameter of the inner surface of the hollow cylindrical portion is set to a dimension that forms a gap between the inner surface and a screw portion of the fixing screw, allowing the stator, which is screwed into the hollow bolt, to move in a direction orthogonal to an axial direction of the fixing screw.

According to another aspect of the present invention, there is provided a position adjustment mechanism for adjusting a position of a position adjustment target portion with respect to a base part, the position adjustment mechanism including: a hollow bolt having a hollow cylindrical portion as a shaft portion and having an outer peripheral screw portion on an outer peripheral surface of the shaft portion that screws into an inner peripheral screw portion provided in a mounting hole of the position adjustment target portion; a nut that screws into the outer screw portion; and a fixing screw that is inserted into the hollow cylindrical portion and screwed into the base part, wherein a diameter of an inner surface of the hollow cylindrical portion is set to a dimension that forms a gap between inner surface and a screw portion of the fixing screw, allowing the position adjustment target portion, which is screwed into the hollow bolt, to move in a direction orthogonal to an axial direction of the fixing screw.

According to another aspect of the present invention, there is provided an adjustment tool for adjusting a position of a position adjustment target portion with respect to a base part by operating a position adjustment mechanism including: a hollow bolt having an outer peripheral screw portion on an outer peripheral surface of a hollow cylindrical portion, the outer peripheral screw portion being screwed with an inner peripheral screw portion provided in a mounting hole of a position adjustment target portion provided so as to be position-adjustable with respect to a base part; a nut screwed with the outer peripheral screw portion; and a fixing screw inserted into the hollow cylindrical portion and screwed with the base part, the adjustment tool including: a first socket member having a first columnar portion with a first fitting portion at a tip end into which a head of the hollow bolt fits; and a second socket member having a second columnar portion into which the first columnar portion is inserted from a base end side and is arranged to be coaxially rotatable relative to the first columnar portion, and which has a second fitting portion at a tip end into which the nut fits, wherein the first columnar portion has a through hole into which a tool for rotating the fixing screw is inserted from the base end side.

According to another aspect of the present invention, there is provided a position adjustment method of a position adjustment target portion with respect to a base part, using an adjustment of claim 13, the method including: rotating the second socket member with the nut fitted to the second fitting portion, inserting a tool for rotating the fixing screw into the through hole of the first columnar portion, loosening the fixing screw with the tool, and making the hollow bolt rotatable; rotating a first socket member with a head of the hollow bolt fitted into the first fitting portion to adjust the distance of the position adjustment target portion relative to the base part; moving the position adjustment target portion in a plane parallel to the base part while the fixing screw is loosened; tightening the nut to fix the distance of the position adjustment target portion relative to the base part; and tightening the fixing screw to fix the position adjustment target portion in a plane parallel to the base part.

### BRIEF DESCRIPTION OF DRAWINGS

FIG. 1A is a side view illustrating a state before a stator using a position adjustment mechanism of an embodiment is attached to a base part corresponding to a device main body;

FIG. 1B is a side view illustrating a state in which a stator using a position adjustment mechanism of an embodiment is attached to a base part and a rotor is attached to a rotation shaft member;

FIG. 1C is a side view illustrating a state in which a stator and a base part illustrated in FIG. 1A are switched up and down;

FIG. 1D is a side view illustrating a state in which a stator illustrated in FIG. 1C is attached to a base part and a rotor is attached to a rotation shaft member;

FIG. 2 is a plan view illustrating a state in which a stator using a position adjustment mechanism of an embodiment is attached to a base part and a rotor is attached to a rotation shaft member;

FIG. 3A is an exploded side view of a position adjustment mechanism of an embodiment;

FIG. 3B is a side view of a position adjustment mechanism of an embodiment;

FIG. 4 is a cross-sectional view taken along a line A-A in FIG. 2;

FIG. 5A is a perspective view of an adjustment tool of an embodiment separated into a first socket member and a second socket member;

FIG. 5B is a perspective view illustrating an adjustment tool of an embodiment and a hexagonal wrench;

FIG. 6A is a front view of a first socket member;

FIG. 6B is a plan view of a first socket member;

FIG. 6C is a bottom view of a first socket member;

FIG. 7A is a front view of a second socket member;

FIG. 7B is a plan view of a second socket member;

FIG. 7C is a side view of a second socket member;

FIG. 7D is a bottom view of a second socket member;

FIG. 8A is a cross-sectional view of an adjustment tool of an embodiment separated into a first socket member and a second socket member;

FIG. 8B is a cross-sectional view of an adjustment tool of an embodiment and a hexagonal wrench;

FIG. 9 is a cross-sectional view of an adjustment tool attached to a position adjustment mechanism of an embodiment;

FIG. 10 is a cross-sectional view illustrating in time series how each part of a position adjustment mechanism moves when an adjustment tool is used;

FIG. 11 is a side view of a position adjustment mechanism in which an opposite side dimension of a nut and an opposite side dimension of a hollow bolt are made to match;

FIG. 12 is a cross-sectional view of an adjustment tool in which an inner diameter of a first fitting portion of a first socket member is made to match an inner diameter of a second fitting portion of a second socket member;

FIG. 13A is a cross-sectional view illustrating a state in which an engagement between a nut and a second fitting portion has been released;

FIG. 13B is a cross-sectional view illustrating a state in which an engagement between a nut, which has risen to an upper limit position, and a second fitting portion has been released;

FIG. 14A is an oblique view of a second socket member in which a tool fitting portion formed on a second columnar portion is hexagonal in shape;

FIG. 14B is an oblique view of a second socket member in which a tool fitting portion is formed on a top surface;

FIG. 15A is an oblique view of an adjustment tool equipped with a retaining mechanism;

FIG. 15B is a cross-sectional view illustrating a first socket member raised relative to a second socket member; and

FIG. 15C is a cross-sectional view illustrating a first socket member pressed down relative to a second socket member.

### DESCRIPTION OF EMBODIMENTS

It is believed that the use of a position adjustment mechanism with multiple functions as described above makes it possible to adjust the position of the stator in a rotary encoder. In addition to rotary encoders, other devices are also expected to have their position adjusted easily by using a position adjustment mechanism with multiple functions as described above.

It is desirable that such position adjustment be as easy as possible. Although the tool disclosed in Japanese Utility Model Laid-Open Publication No. S63-74278 is also intended to operate multiple fixtures, it can only adjust the adjustment target in one direction and is considered to have poor versatility.

The following describes an embodiment with reference to the drawings.

### EMBODIMENT

### [Rotary Encoder]

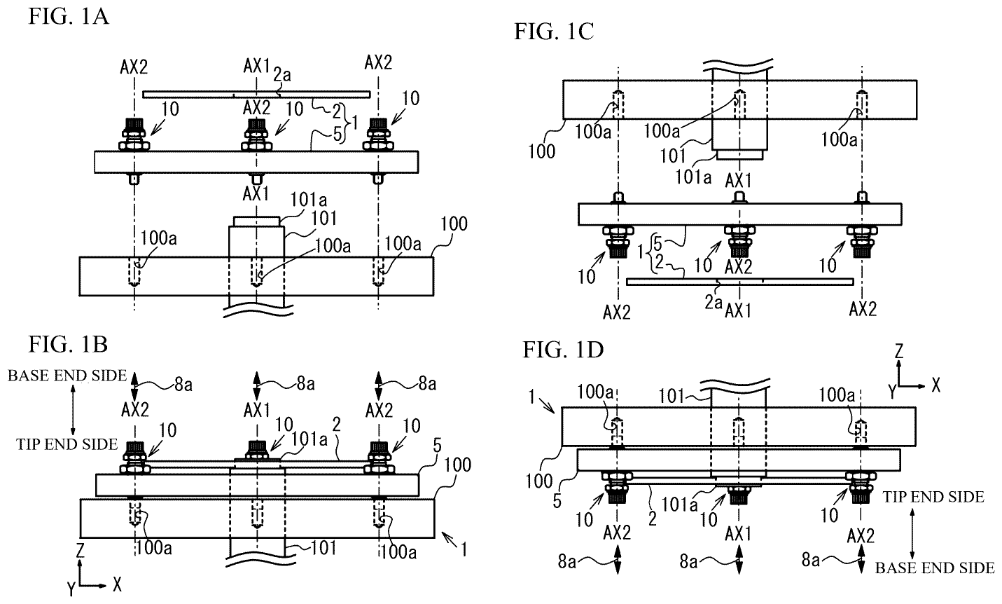

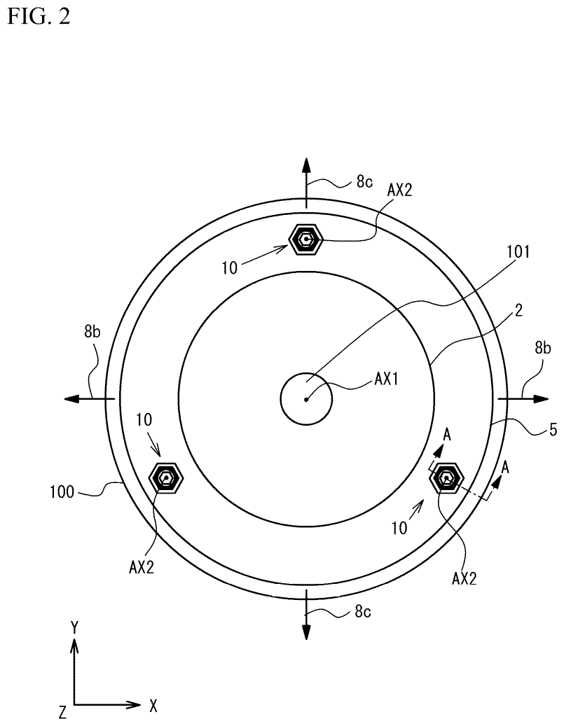

First, a rotary encoder 1 including a stator 5 whose position is adjusted by a position adjustment mechanism 10 of this embodiment will be described with reference to FIG. 1A to FIG. 1D and FIG. 2. The rotary encoder 1 is installed in, for example, various devices with rotating parts. These devices include a base part 100 that is the main body of the device, and a rotation shaft member 101 that is rotatably provided relative to the base part 100 as a rotation part. The stator 5 is an example of a position adjustment target part whose position is adjusted by the position adjustment mechanism 10. The rotary encoder 1 includes a rotor 2 and the stator 5. The rotor 2 has a scale pattern (not illustrated) and is sometimes called a rotary scale. The rotor 2 is a disk-shaped member with a fitting hole 2a in the center. The rotor 2 is attached to the rotation shaft member 101 by fitting the fitting hole 2a into the rotation shaft member 101 so that the central axis of the rotor 2 coincides with the rotation axis AX1 of the rotation shaft member 101. The stator 5 has a transmitting/receiving unit that transmits and receives signals to and from the scale pattern. The stator 5 is attached to the base part 100. At this time, the rotor 2 and the stator 5 are required to be installed in parallel without being eccentric to each other.

Therefore, in this embodiment, the position of the stator 5 can be adjusted by the position adjustment mechanism 10, and the stator 5 can be installed in parallel and at any distance from the rotor 2 without being eccentric. In other words, by using the position adjustment mechanism 10 of this embodiment, the inclination between the rotor 2 and the stator 5 can be adjusted to make them parallel to each other, and the distance between the rotor 2 and the stator 5 can be adjusted. Furthermore, by using the position adjustment mechanism 10, the eccentricity adjustment of the stator 5 with respect to the rotation axis AX1 can be easily performed.

The base part 100, the stator 5, and the rotor 2 are arranged in a stacked state along the Z direction. As illustrated in FIG. 1A and FIG. 1B, the base part 100, the stator 5, and the rotor 2 may be arranged in the order of the base part 100, the stator 5, and the rotor 2 from the bottom. In addition, by switching the upper and lower positions, as illustrated in FIG. 1C and FIG. 1D, the rotor 2, the stator 5, and the base part 100 may be arranged in that order from the bottom. Note that the following description will focus on the aspects illustrated in FIG. 1A and FIG. 1B.

The position adjustment mechanisms 10 are arranged on the stator 5 at equal intervals in the circumferential direction, spaced apart by 120°. The stator 5 is attached to the base part 100 by screwing the position adjustment mechanisms 10 into screw holes 100a provided in the base part 100. Note that the plurality of position adjustment mechanisms 10 may be provided along the circumferential direction of the stator. It is preferable that the position adjustment mechanisms 10 are provided in three or more locations. When the position adjustment mechanisms 10 are arranged in three locations, it is preferable that they are arranged at equal intervals in the circumferential direction, spaced apart by 120°, as in this embodiment.

Each of the position adjustment mechanisms 10 can raise and lower the point on the stator 5 where the position adjustment mechanism 10 is located in the Z-axis direction, as illustrated by an arrow 8a in FIG. 1B. By fixing the plurality of position adjustment mechanisms 10 at different positions in the Z-axis direction, the stator 5 can be parallel to the rotor 2 and can be installed at any distance.

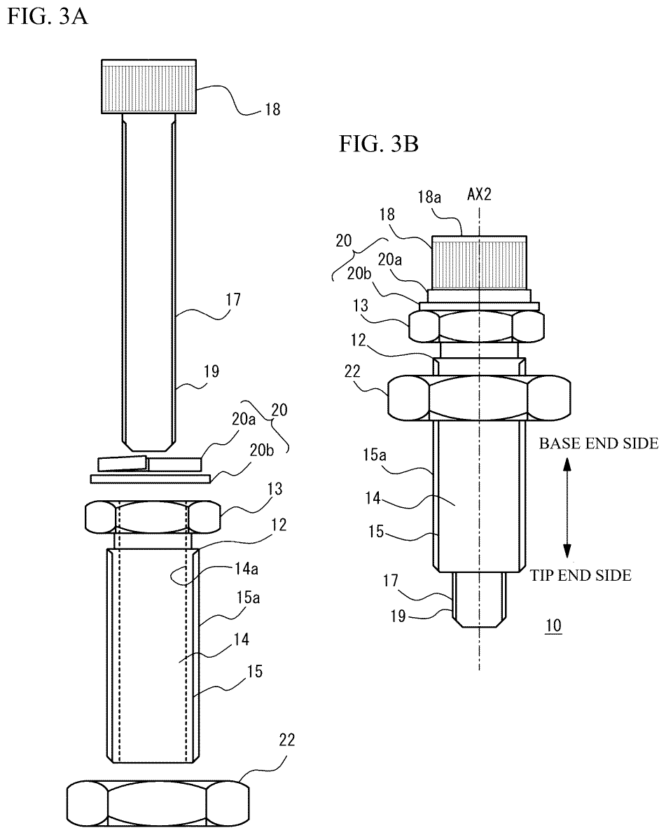

Each of the position adjustment mechanisms 10 can move the stator 5 relative to the central axis AX2 of the screw hole 100a by loosening the fixing screw 17. Therefore, each of the position adjustment mechanisms 10 can move the stator 5 along the X-axis direction, as illustrated by an arrow 8b in FIG. 2, or along the Y-axis direction, as illustrated by an arrow 8c. This allows the stator 5 to be installed without being eccentric with respect to the rotor 2. Furthermore, if the fixing screw is loosened to a distance where pressure is applied by a pressurizing mechanism 20 (see FIG. 3A and FIG. 3B), it becomes easy to finely adjust the movement of the stator 5, and it becomes easy to accurately align the eccentricity with respect to the rotor 2.

In the following explanation, one side in the Z-axis direction as illustrated in FIG. 1B will be referred to as the base end side, and the other side as the tip end side.

### [Position Adjustment Mechanism]

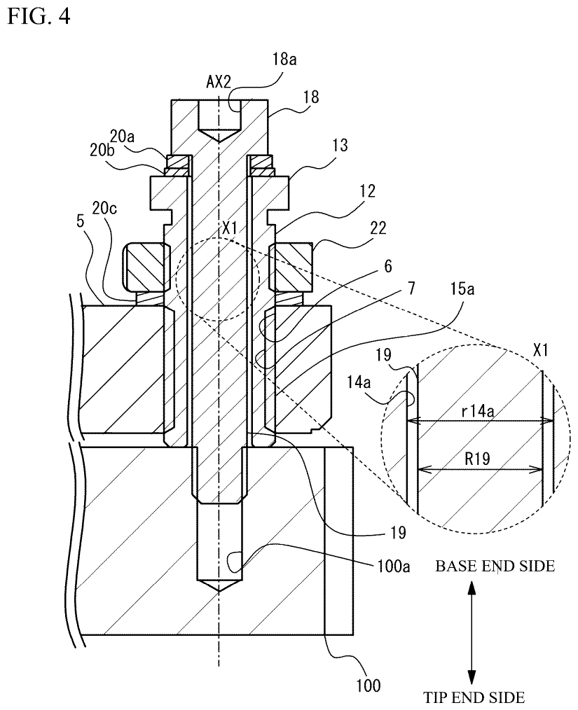

Next, the configuration of the position adjustment mechanism 10 will be described in detail with reference to FIG. 3A, FIG. 3B, and FIG. 4. The position adjustment mechanism 10 includes a hollow bolt 12, a fixing screw 17, and a nut 22. The position adjustment mechanism 10 also includes the pressurizing mechanism 20.

The hollow bolt 12 includes a head 13 that has a hexagonal shape in a plan view on the base end side. However, the shape of the head 13 is not limited to the hexagonal shape, and various shapes that are known in the art can be adopted. A hollow cylindrical portion 14, which corresponds to the shaft portion of the hollow bolt 12 and extends toward the tip side, is connected to the head 13. The hollow cylindrical portion 14 has an inner peripheral surface 14a with an inner diameter r14a. The inner diameter r14a is the diameter of the inner peripheral surface 14a of the hollow cylindrical portion 14. An outer peripheral screw portion 15a is formed on an outer peripheral surface 15 of the hollow cylindrical portion 14. In other words, the hollow bolt 12 is a male screw. The outer peripheral screw portion 15a is screwed with an inner peripheral screw portion (female screw portion) 7 provided in a mounting hole 6 of the stator 5. The stator 5 can move up and down along the Z-axis direction according to the rotation direction of the hollow bolt 12 by rotating the hollow bolt 12, and the distance between the stator 5 and the base part 100, that is, the position in the height direction (Z-axis direction) is adjusted. As a result, the distance between the rotor 2 and the stator 5 is adjusted.

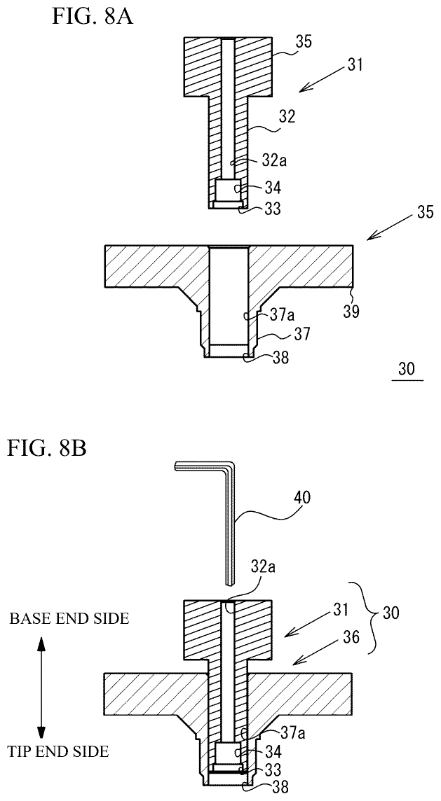

The fixing screw 17 has a head 18 provided on the base end side. The head 18 has a tool hole 18a. In this embodiment, the tool hole 18a is a hexagonal hole and can be rotated using a hexagonal wrench (see FIG. 8B and the like). The tool hole 18a may have other shapes and may have various shapes that are well known in the art. The tool hole 18a may have, for example, a + (plus) or − (minus) shape. A screw portion 19 is connected to the head 18 and is rod-shaped extending toward the tip side and has an outer diameter R19. The screw portion 19 is screwed into the screw hole 100a provided in the base part 100. The fixing screw 17 can also fix the stator 5 to the base part 100.

The outer diameter R19 of the screw portion 19 is smaller than the inner diameter r14a of the inner peripheral surface 14a of the hollow cylindrical portion 14. By making the outer diameter R19<the inner diameter r14a, a gap is formed between the inner peripheral surface 14a and the screw portion 19. As a result, when the fixing screw 17 is loosened, the hollow bolt 12 can move in the X direction or the Y direction relative to the screw portion 19. Since the stator 5 is attached to the hollow bolt 12, the stator 5 can move in the X direction or the Y direction relative to the screw portion 19. In other words, the stator 5 can move in the X direction or the Y direction relative to the central axis AX2 of the screw hole 100a into which the screw portion 19 is screwed, and the eccentricity of the stator 5 relative to the rotor 2 can be eliminated. In this way, the position of the stator 5 can be adjusted within a plane (X-Y plane) parallel to the base part 100.

In order for the hollow bolt 12 to be rotatable, it is necessary to loosen the fixing screw 17 and the nut 22. The fixing screw 17 and the nut 22 are loosened and the hollow bolt 12 rotates, allowing the stator 5 to move up and down as described above.

The nut 22 is screwed onto the outer peripheral screw portion 15a of the hollow bolt 12. The nut 22 is disposed on the Z-direction upper side of the stator 5 that is screwed onto the outer peripheral screw portion 15a of the hollow bolt 12. In other words, the nut 22 is disposed between the stator 5 and the head 13 of the hollow bolt 12. The dimensions of the nut 22 in this embodiment, specifically the opposite side dimension, which is the distance between the opposing sides (faces), is larger than the opposite side dimension of the head 13 of the hollow bolt 12. The outer shape of the nut 22 in this embodiment is hexagonal, but the outer shape of the nut 22 is not limited to a hexagon, and various shapes known in the art can be adopted. In addition, in this specification, the above-mentioned opposite side dimensions are compared when comparing the sizes of nuts and bolts, but the diagonal dimension, which is the distance between opposing corners, may be used instead of the opposite side dimension. In short, a dimension that allows the size of nuts and bolts to be compared can be adopted. The stator 5 has the inner peripheral screw portion 7, and the stator 5 itself has a structure similar to that of a nut. Therefore, the nut 22 can obtain a so-called double nut effect together with the stator 5. Therefore, when the nut 22 is tightened and fastened to the stator 5, it is possible to stop the rotation of the hollow bolt 12 and maintain the position of the stator 5 in the Z-axis direction.

In the position adjustment mechanism 10, the nut 22 is located on the tip side of the head 13 of the hollow bolt 12. A second fitting portion 38 fits into the nut 22 as described in detail later. A first fitting portion 33 fits into the head 13 as described in detail later. A first columnar portion 32 provided with the first fitting portion 33 and a second columnar portion 37 provided with the second fitting portion 38 are arranged coaxially, but the first columnar portion 32 is arranged inside the second columnar portion 37. Therefore, by making the opposite side dimension of the nut 22 larger than the opposite side dimension of the head 13 of the hollow bolt 12, it is possible to make it easier to fit the nut 22 into the second fitting portion 38 and fit the head 13 into the first fitting portion 33. However, it is sufficient that the opposite side dimension of the nut 22 is equal to or larger than the opposite side dimension of the head 13 of the hollow bolt 12. In other words, the opposite side dimension of the nut 22 may be the same value as the opposite side dimension of the head 13 of the hollow bolt 12. The embodiments will be described as modified embodiments later.

Here, the action of the fixing screw 17 and the nut 22 on the hollow bolt 12 will be summarized and explained. First, when both the fixing screw 17 and the nut 22 are loosened, the hollow bolt 12 can rotate. Furthermore, when the fixing screw 17 is loosened, the hollow bolt 12 is permitted to move in the X and Y directions. Next, when the fixing screw 17 is loosened and the nut 22 is tightened to be in a fastened state, the hollow bolt 12 is permitted to move in the X and Y directions, and the rotation of the hollow bolt 12 is stopped. If the fixing screw 17 is turned without fixing the rotation of the hollow bolt 12 with the nut 22, the fixing screw 17 and the hollow bolt 12 will rotate together, and the stator 5 may be displaced in all directions of X, Y, and Z. In this case, it is expected that fine position adjustment of the stator 5, for example, of 0.1 mm or less, will be difficult. By appropriately tightening and loosening the fixing screw 17 and the nut 22, the stator 5 can be maintained in a desired state.

In this embodiment, a first washer 20a and a second washer 20b are disposed between the head 18 of the fixing screw 17 and the head 13 of the hollow bolt 12. The first washer 20a is a spring washer, and the second washer 20b is a flat washer. The first washer 20a and the second washer 20b are included in the pressurizing mechanism 20. The pressurizing mechanism 20 has an elastic force that biases the hollow bolt 12 toward the base part 100. The first washer 20a is an example of a spring member, and exerts an elastic force (biasing force) that biases the hollow bolt 12 toward the base part 100. The second washer 20b suppresses slippage between the fixing screw 17 and the hollow bolt 12, and distributes the biasing force to stabilize the positional relationship between the two. The pressurizing mechanism 20 may include other elastic members, such as a compression spring, instead of or in addition to the first washer 20a. The pressurizing mechanism 20 biases the hollow bolt 12 with a force that allows the hollow bolt 12 to move slightly. This makes it easier to finely adjust the position of the stator 5 integrated with the hollow bolt 12. In addition, by providing the pressurizing mechanism 20, the tip of the hollow bolt 12 is pressed against the base part 100 even when the base end side of the position adjustment mechanism 10 is positioned on the lower side, as illustrated in FIG. 1C and FIG. 1D. In other words, the position and attitude of the stator 5 can be easily adjusted regardless of the attitude of the rotary encoder 1. In addition, a third washer 20c is disposed between the nut 22 and the stator 5.

### [Adjustment Tool]

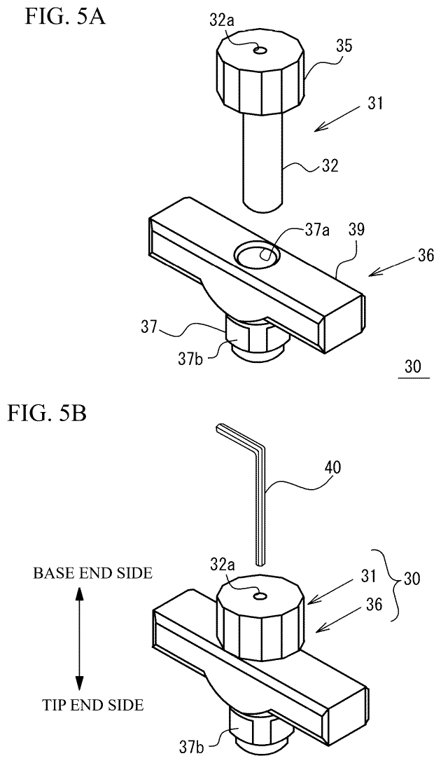

Next, the adjustment tool 30 for operating the position adjustment mechanism 10 will be described with reference to FIG. 5 to FIG. 8. The adjustment tool 30 includes a first socket member 31 and a second socket member 36. The adjustment tool 30 is used by combining the first socket member 31 and the second socket member 36. The adjustment tool 30 can also be used by combining a hexagonal wrench 40.

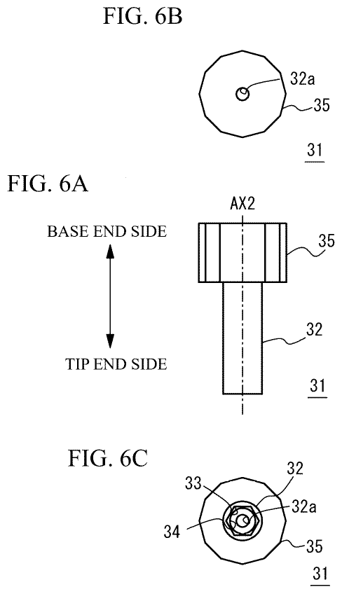

The first socket member 31 includes the first columnar portion 32. The first columnar portion 32 is hollow and includes a through hole 32a. As illustrated in FIG. 8B, the hexagonal wrench 40 is inserted into the through hole 32a. The first columnar portion 32 includes the first fitting portion 33 at its tip into which the head 13 of the hollow bolt 12 fits. The first fitting portion 33 communicates with the through hole 32a and has a shape that corresponds to the shape of the head 13. In this embodiment, the first fitting portion 33 is hexagonal. The first columnar portion 32 is provided with a head storage portion 34 for storing the head 18 of the fixing screw 17 on the base end side of the first fitting portion 33. The fixing screw 17 reaches the head 18 through the through hole 32a and is rotated by the hexagonal wrench 40 fitted into the tool hole 18a (see FIG. 3B). The first socket member 31 is provided with a rotation operation portion 35 at the end on the base end side. As illustrated in FIG. 6B, the rotation operation portion 35 is provided with a regular dodecagonal shape in a plan view. The shape of the rotation operation portion 35 is not limited to a regular dodecagon and can be appropriately selected in consideration of the operability of the operator. The rotation operation portion 35 may be, for example, a lever-shaped portion, but is preferably circular or a polygonal shape close to a circle.

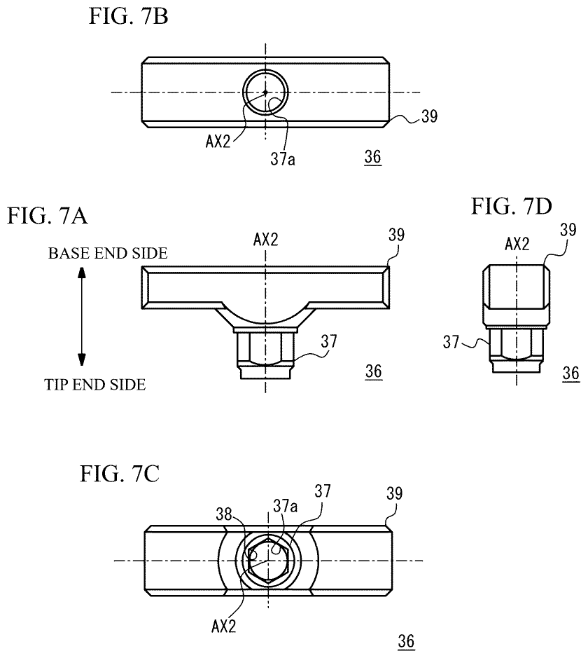

The second socket member 36 is provided with the second columnar portion 37. The second columnar portion 37 is hollow and has a through hole 37a. The first columnar portion 32 of the first socket member 31 is inserted into the through hole 37a. The first columnar portion 32 and the second columnar portion 37 are coaxially rotatable relative to each other. The second columnar portion 37 has the second fitting portion 38 into which the nut 22 fits at its tip. The second fitting portion 38 is in communication with the through hole 37a and has a shape corresponding to the shape of the nut 22. The second fitting portion 38 in this embodiment is hexagonal. The second socket member 36 has a handle portion 39 on the base end side of the second columnar portion 37. The handle portion 39 extends in a direction orthogonal to the axial direction of the second columnar portion 37. In the front view illustrated in FIG. 7A, the handle portion 39 in this embodiment extends on both sides of the second columnar portion 37 and forms a T-shape together with the second columnar portion 37. The shape of the handle portion 39 is not limited to a T-shape and may be another shape. However, considering that the second socket member 36 is used in combination with the first socket member 31, it is desirable that the handle portion 39 has a shape that protrudes laterally beyond the rotation operation portion 35. A tool fitting portion 37b is formed on the outer peripheral surface of the second columnar portion 37. The tool fitting portion 37b has four smooth surfaces formed by shifting by 90°. The second socket member 36 can also be operated by fitting another tool, such as a wrench, into the tool fitting portion 37b. By using the other tool, the nut 22 can be tightened. In addition, for example, by using a torque wrench, the tightening torque can be managed.

### [Position Adjustment Work]

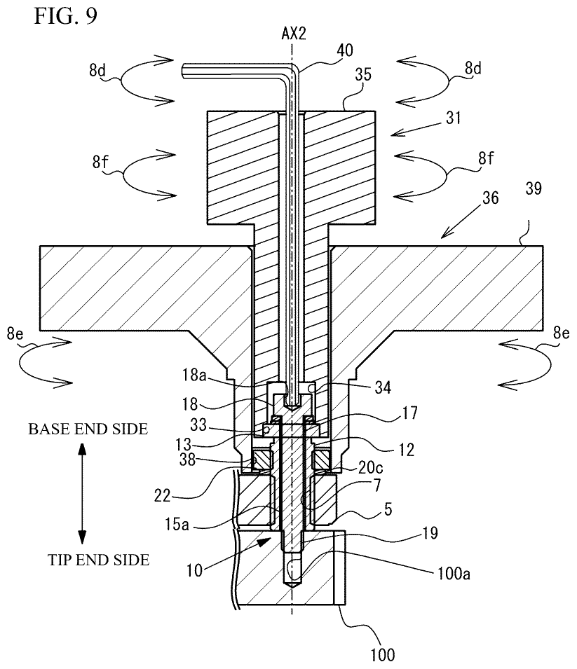

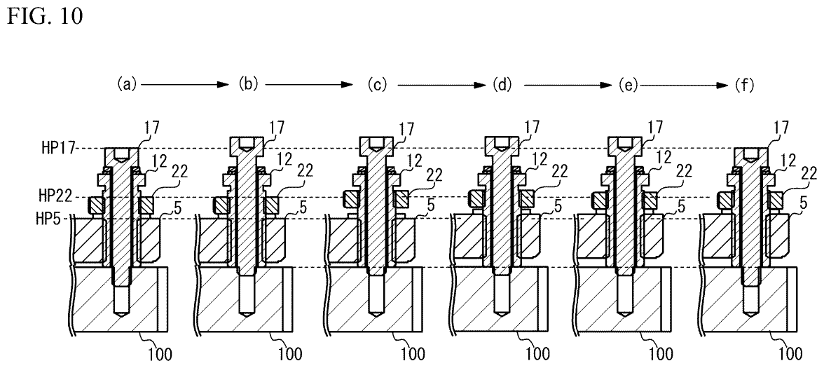

Next, the work of adjusting the position of the stator 5 by operating the position adjustment mechanism 10 using the adjustment tool 30 will be described with reference to FIG. 9 and FIG. 10. The position adjustment mechanisms 10 are installed at three locations on the stator 5, and position adjustment is performed at each of the position adjustment mechanisms 10. In the following description, the adjustment work at one of the position adjustment mechanism 10 will be described.

Referring to FIG. 9, the stator 5 is attached to the base part 100 by the position adjustment mechanism 10. Specifically, the inner peripheral screw portion 7 of the stator 5 is screwed into the outer peripheral screw portion 15a of the hollow bolt 12 into which the fixing screw 17 is inserted, and the hollow bolt 12 does not rotate due to the nut 22. The screw portion 19 of the fixing screw 17 is fastened to the screw hole 100a of the base part 100, so that the movement in the X, Y, and Z directions is restricted and fixed.

The first socket member 31 and the second socket member 36 of the adjustment tool 30 are attached to the position adjustment mechanism 10. The head 18 of the fixing screw 17 is stored in the head storage section 34. The hexagonal wrench 40 fits into the tool hole 18a provided in the head 18 of the fixing screw 17. This allows the fixing screw 17 to rotate as illustrated by an arrow 8d, and the fixing screw 17 can be in a fastened or loosened state. The second socket member 36 also allows the nut 22 to be in a fastened or loosened state. Fastening the fixing screw 17 and the nut 22 can prevent the hollow bolt 12 from rotating. After completing the position adjustment of the stator 5, the position adjustment mechanism 10 is in a state in which the fixing screw 17 is fastened. The rotary encoder 1 is used with the fixing screw 17 fastened. Loosening the fixing screw 17 and the nut 22 can make the hollow bolt 12 rotatable. When adjusting the position of the stator 5, the fixing screw 17 and the nut 22 are loosened. The hollow bolt 12 can be rotated by loosening the fixing screw 17 and the nut 22. The position of the stator 5 in the Z direction can be adjusted by rotating the hollow bolt 12.

In this embodiment, the outer diameter R19 of the screw portion 19 and the inner diameter r14a of the inner peripheral surface 14a of the hollow cylindrical portion 14 have a relationship of the outer diameter R19<the inner diameter r14a. Therefore, by loosening the fixing screw 17, the stator 5 can be moved in the X direction or the Y direction with respect to the central axis AX2 of the screw hole 100a.

The second fitting portion 38 is fitted to the nut 22. As a result, by operating the second socket member 36, the nut 22 can be rotated as illustrated by an arrow 8e. The nut 22 is screwed onto the outer peripheral screw portion 15a of the hollow bolt 12. The nut 22 descends relative to the hollow bolt 12 and is fastened to the stator 5 via the third washer 20c, thereby making it possible to fix the stator 5 to the hollow bolt 12. Here, the nut 22 descending relative to the hollow bolt 12 means that the nut 22 moves toward the tip side of the hollow bolt 12.

The first fitting portion fits into the head 13 of the hollow bolt 12. As a result, by operating the first socket member 31, the hollow bolt 12 can be rotated as illustrated by an arrow 8f. The inner peripheral screw portion 7 of the stator 5 is screwed into the outer peripheral screw portion 15a of the hollow bolt 12. The stator 5 itself is attached to the base part 100 at three points. Therefore, the stator 5 does not rotate together with the rotation of the hollow bolt 12 in each of the position adjustment mechanisms 10. When the hollow bolt 12 rotates, the location where the position adjustment mechanism 10 is installed on the stator 5 moves up and down. By adjusting the height position at the location where the position adjustment mechanism 10 is installed on the stator 5, the relative positional relationship between the rotation axis and the stator 5 can be adjusted, and as a result, the stator 5 can be installed on a vertical plane of the rotation axis.

As described above, the position adjustment mechanism 10 includes three fasteners: the hollow bolt 12, the fixing screw 17, and the nut 22. For this position adjustment mechanism 10, the adjustment tool 30 includes the first socket member 31 and the second socket member 36, which are combined to be rotatable on the same axis. Furthermore, the adjustment tool 30 includes the through hole 32a into which the hexagonal wrench 40, which is another tool installed on the same axis as the first socket member 31 and the second socket member 36, is inserted. Therefore, the position adjustment mechanism 10 can be easily operated by using the adjustment tool 30.

When the operator holds the handle portion 39, the first columnar portion 32 is inserted into the second columnar portion 37. The hexagonal wrench 40 is inserted into the through hole 32a. Therefore, the first socket member 31 is mounted on the second socket member 36 and will not fall off the second socket member 36. In addition, the hexagonal wrench 40 will not fall off the adjustment tool 30.

The operator can hold the three tools, that is, the first socket member 31, the second socket member 36, and the hexagonal wrench 40 included in the adjustment tool 30, with one hand. This eliminates the need to switch between general tools such as a conventional wrench, and shortens the work time. In this way, the three tools can be held with one hand, and the other hand can operate the required tool at the required time. Furthermore, the hollow bolt 12, the fixing screw 17, and the nut 22 can be easily accessed, making the work easier.

As an example of the work method, for example, the operator can hold the handle portion 39 of the second socket member 36 so that it is supported by the middle finger, the ring finger, and the palm. In this state, the operator can freely use his thumb and index finger. Therefore, the operator can use his thumb and index finger to rotate the rotation operation portion 35 of the first socket member 31 and the hexagonal wrench 40. The operator can operate the second socket member 36 by bending the wrist toward the palm side or the back side or by moving the whole arm while gripping the handle portion 39. The operator only needs to operate the part that is engaged with the fastener to be rotated. When the operator wants to rotate the nut 22, the operator only needs to rotate the second socket member 36 without touching the first socket member 31 or the hexagonal wrench 40. When the operator wants to rotate the hollow bolt 12, the operator only needs to rotate the first socket member 31 without rotating the second socket member 36 or touching the hexagonal wrench 40. When the operator wants to rotate the fixing screw 17, the operator only needs to rotate the hexagonal wrench 40 without rotating the second socket member 36 or touching the first socket member 31.

The operator can work in a way that is easy for him/her to operate. By using the adjustment tool 30, the operator can easily perform the adjustment work when the rotor 2, the stator 5, and the base part 100 are in a horizontal position or in an upside-down environment as illustrated in FIG. 1C and FIG. 1D.

If the adjustment tool 30 is not used, the operator has to operate a hexagonal wrench for the fixing screw 17, a spanner for the hollow bolt 12, and a spanner for the nut 22. It is very difficult for one operator to operate these multiple tools at the same time. In addition, the handle of a spanner is long, making it difficult to work in a narrow space. By using the adjustment tool 30 of this embodiment, one operator can easily operate the position adjustment mechanism 10. In addition, the adjustment tool 30 is used in a state where it is coaxially capped with the position adjustment mechanism 10, making it easy to work in a narrow space.

Here, referring to FIG. 10, an example of the movement of each part of the position adjustment mechanism 10 and the stator 5 when the position of the stator 5 is adjusted will be described. For convenience of drawing, FIG. 10 omits an adjustment tool 30 and illustrates only the movement of each part included in the position adjustment mechanism 10 and the stator 5.
(a) in FIG. 10 illustrates the initial state. In the initial state, the fixing screw 17 and the nut 22 are tightened, and the hollow bolt 12 cannot rotate. In FIG. 10, the height position of the fixing screw 17 in this initial state is illustrated as HP17, the height position of the nut 22 is illustrated as HP22, and the height position of the stator 5 is illustrated as HP5.
(b) in FIG. 10 illustrates the fixing screw 17 loosened from the initial state, and the height position of the fixing screw 17 is higher than the initial state. However, in the state illustrated in (b), the nut 22 is still in a fixed state. Therefore, as illustrated in (c), the nut 22 is loosened. This allows the hollow bolt 12 to rotate, and the stator 5 can be raised or lowered.

When the hollow bolt 12 is rotated in a state in which there is room to move the stator 5 as illustrated in (c), the stator 5 rises or lowers. After the stator 5 has been moved to a desired position as illustrated in (d), the nut 22 is tightened as illustrated in (e) to fasten the stator 5, so that the stator 5 can be held at any distance. By adjusting the height position of the stator 5 in this way at multiple points, the inclination of the stator 5 relative to the rotor 2 can be eliminated, and the stator 5 can be set parallel to the rotor 2 and at any height. Note that when the fixing screw 17 is loosened as illustrated in (b) to (e), the stator 5 can be moved in the X direction or Y direction relative to the central axis AX2 of the screw hole 100a.

After the position adjustment of the stator 5 is completed, the fixing screw 17 is tightened as illustrated in (f). This fixes the eccentricity direction and height direction of the stator 5. Once the adjustment of the stator 5 is completed by the three position adjustment mechanisms 10, the rotary encoder 1 can be used.

### Effects

The rotary encoder 1 of this embodiment is equipped with the position adjustment mechanism 10, which is equipped with the hollow bolt 12 whose outer peripheral screw portion 15a is screwed into an inner peripheral screw portion 7 of the stator 5, which is the part to be adjusted in position. This allows the hollow bolt 12 to be rotated and the height position of the stator 5 to be adjusted. The position adjustment mechanism 10 is equipped with the nut 22 that screws into the outer peripheral screw portion 15a, and the fixing screw 17 that is inserted into the hollow cylindrical portion 14 and screwed into the base part 100. As a result, the hollow bolt 12 does not rotate, and the stator 5 can be fixed.

In the position adjustment mechanism 10 of this embodiment, the opposite side dimension of the nut 22 is larger than the opposite side dimension of the head 13 of the hollow bolt 12. This makes it easier for the head 13 to fit into the first fitting portion 33, and the nut 22 to fit into the second fitting portion 38.

The diameter of the inner peripheral surface 14a of the hollow cylindrical portion 14 is set to a dimension that forms a gap between the screw portion 19 of the fixing screw 17 and the hollow bolt 12, allowing the stator 5, which is screwed into the hollow bolt 12, to move in a direction orthogonal to the axial direction of the fixing screw 17. This allows the stator 5 to move in the X and Y directions relative to the central axis AX2 of the screw hole 100a.

Providing the pressurizing mechanism 20 makes it easy to move the stator 5 finely, and makes it easier to adjust the eccentricity direction.

Furthermore, providing the pressurizing mechanism 20 makes it possible to maintain the position of the stator 5 when the rotor 2, the stator 5, and the base part 100 are oriented sideways or in an upside-down environment.

The position adjustment mechanism of the rotary encoder 1 of this embodiment can include the plurality of position adjustment mechanisms 10 along the circumferential direction of the stator. For example, the position adjustment mechanisms can be arranged at equal intervals around the stator 5, spaced 120° apart. This allows the stator 5 to be stably attached to the base part 100, which is the main body of the device.

The adjustment tool 30 comprises the first socket member 31 having the first columnar portion 32 with the first fitting portion 33, and the second socket member 36 which is rotatable coaxially with the first columnar portion 32 and has the second columnar portion 37 with the second fitting portion 38. This allows for easy operation of the position adjustment mechanism 10.

The first columnar portion 32 of the adjustment tool 30 comprises the through hole 32a into which the hexagonal wrench 40 is inserted to rotate the fixing screw 17 from the base end side. This allows for easy operation of the hexagonal wrench 40 to rotate the fixing screw 17.

The second socket member 36 is provided with the handle portion 39 that extends in a direction orthogonal to the axial direction of the second columnar portion 37. This makes it easier to operate the adjustment tool 30.

The adjustment tool 30 and the hexagonal wrench 40 can be held in one hand, and the operation time can be shortened by eliminating the need to change hands. In addition, the operation is easier when the rotor 2, the stator 5, and the base part 100 are in a horizontal or upside-down environment.

Note that the part to be adjusted in position in this embodiment is the stator 5, but the position adjustment mechanism 10 and the adjustment tool 30 are not limited to the position adjustment work of the stator 5, and can also be used for position adjustment work of other devices and components.

### Modified Embodiment 1

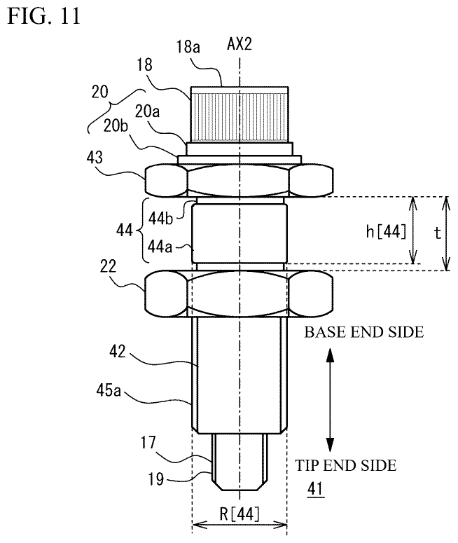

Next, a position adjustment mechanism 41 and an adjustment tool 50 of Modified Embodiment 1 will be described with reference to FIG. 11 to FIG. 13.

The position adjustment mechanism 41 has a hollow bolt 42 in place of the hollow bolt 12 in the position adjustment mechanism 10. The opposite side dimension of a head 43 of the hollow bolt 42 matches the opposite side dimension of the nut 22. In Modified Embodiment 1, the opposite side dimension of the head 43 is made larger than the opposite side dimension of the head 13, thereby matching the opposite side dimension of the head 43 and the nut 22.

The hollow bolt 42 has a cylindrical portion 44 below the head 43, that is, on the tip side of the head 43. The cylindrical portion 44 is not provided with a screw thread, and is formed as a portion having a simple cylindrical shape. An outer peripheral screw portion 45a is provided on the tip side of the cylindrical portion 44, and the nut 22 screws onto this outer peripheral screw portion 45a. The outer diameter R[44] of the cylindrical portion 44 matches the outer diameter of the outer peripheral screw portion 45a, and since the cylindrical portion 44 is not provided with a screw thread, the nut 22 cannot move on the cylindrical portion 44. In other words, the cylindrical portion 44 defines the upper limit position to which the nut 22 can move toward the base end. Referring to FIG. 11, the cylindrical portion 44 includes a first portion 44a and a second portion 44b that forms a constriction between the first portion 44a and the head 43. The distance from the head 43 to the tip of the first portion 44a is the height h[44] of the cylindrical portion 44.

Referring to FIG. 11, the distance between the head 43 and the nut 22 is the interval t. The interval t varies depending on the position of the nut 22. The interval t is the minimum interval tmin when the nut 22 is moved to the upper limit position.

Even with this position adjustment mechanism 41, the position adjustment of the stator 5 can be easily performed as with the position adjustment mechanism 10.

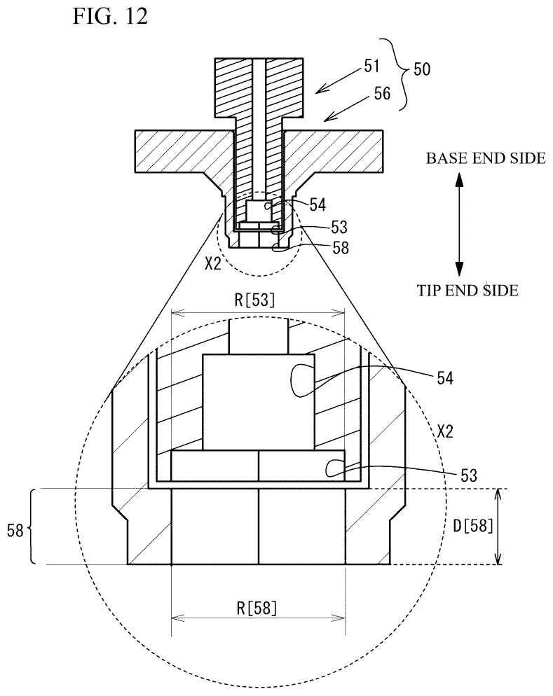

To operate the position adjustment mechanism 41, the adjustment tool 50 illustrated in FIG. 12 is used instead of the adjustment tool 30. The adjustment tool 50 includes a first socket member 51 and a second socket member 56.

The first socket member 51 includes a first fitting portion 53 and a head storage portion 54. The head storage portion 54 corresponds to the head storage portion 34. The first fitting portion 53 corresponds to the first fitting portion 33. The shape of the first fitting portion 53 is hexagonal like the first fitting portion 33, and the diameter of the inscribed circle is an inner diameter R[53]. The inner diameter R[53] is set according to the opposite side dimension of the head 43 of the hollow bolt 42. In Modified Embodiment 1, as described above, the opposite side dimension of the head 43 is made larger than the opposite side dimension of the head 13, so that the opposite side dimension of the head 43 and the opposite side dimension of the nut 22 are made to match. Therefore, the R[53] is larger than the diameter of the inscribed circle of the first fitting portion 33.

The second socket member 56 has a second fitting portion 58. The second fitting portion 58 corresponds to the second fitting portion 38. The shape of the second fitting portion 58 is hexagonal like the second fitting portion 38, and the diameter of the inscribed circle is an inner diameter R[58]. The inner diameter R[58] is set to match the opposite side dimension of the nut 22.

Here, as described above, the opposite side dimension of the head 43 of the hollow bolt 42 and the opposite side dimension of the nut 22 match. Therefore, the inner diameter R[58] matches the inner diameter R[53]. The inner diameter R[53] and the inner diameter R[58] are larger than the outer diameter R[44].

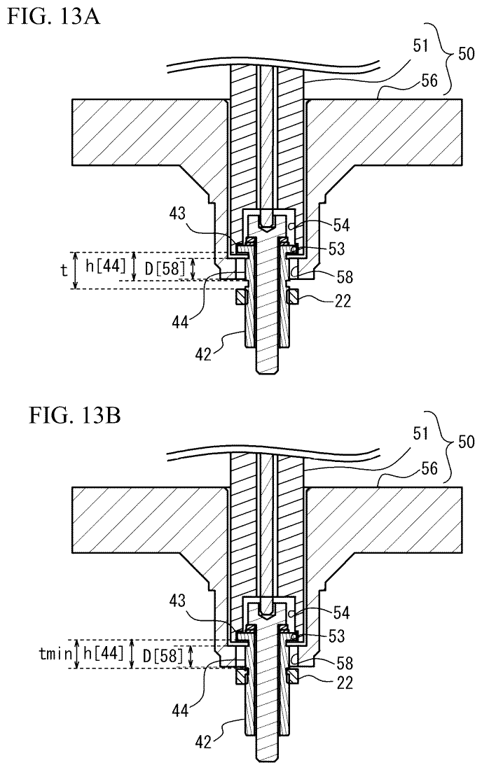

Referring to FIG. 12, the second fitting portion 58 has a depth D[58]. Referring to FIG. 13A, the depth D[58] is smaller than the interval t and smaller than the height h[44] of the cylindrical portion 44. Referring to FIG. 13B, the depth D[58] is smaller than the minimum interval tmin. In other words, the depth D[58] is smaller than the interval t regardless of the position of the nut 22.

The reason for this configuration is to make it easier to remove the second socket member 56. The opposite side dimension of the head 43 of the hollow bolt 42 provided in the position adjustment mechanism 41 is the same as the opposite side dimension of the nut 22. Here, it is assumed that the circumferential orientation of the nut 22 and the circumferential orientation of the head 43 of the hollow bolt 42 are different, and the positions of the hexagons do not match. Here, if the second fitting portion 58 simply has a hexagonal shape, the second socket member 56, which follows the orientation of the nut 22, will collide with the head 43 and cannot be removed.

Then, Modified Embodiment 1 has the shape and size relationship of each part as described above. In FIG. 13A and FIG. 13B, the depth D[58] is smaller than the interval t and smaller than the height h[44] of the cylindrical portion 44. Therefore, the second socket member 56 can be pulled up so that the second fitting portion 58 and the cylindrical portion 44 face each other.

Here, the inner diameter R[58] is larger than the outer diameter R[44]. Therefore, the second socket member 56 can be rotated to change its circumferential position. Therefore, the second socket member 56 is rotated to match the hexagonal position of the second fitting portion 58 with the position of the head 43. This allows the second fitting portion 38 to pass through the head 43, and the operator can remove the second socket member 56.

### Modified Embodiment 2

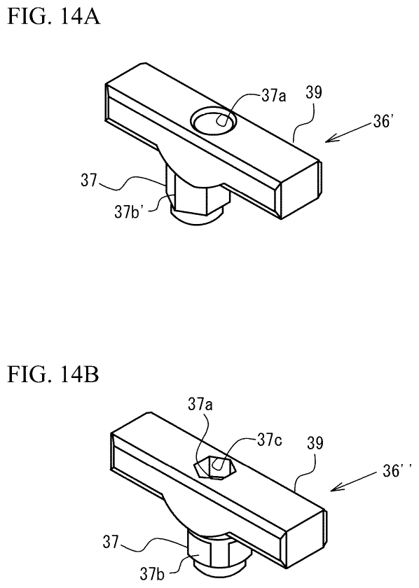

Next, Modified Embodiment 2 will be described with reference to FIG. 14A. The second socket member 36 illustrated in FIG. 5A has four smooth surfaces on the outer peripheral surface of the second columnar portion 37. In contrast, a tool fitting portion 37b′ of a second socket member 36′ of Modified Embodiment 2 has a hexagonal outer peripheral shape. The tool fitting portion 37b′ can also be operated by fitting another tool such as a spanner. The nut 22 can be tightened by using another tool. Furthermore, the tightening torque can be controlled by using a torque spanner, for example. The shape of the tool fitting portion is not limited to a square or hexagonal shape, and may be another polygonal shape.

### Modified Embodiment 3

Next, Modified Embodiment 3 will be described with reference to FIG. 14B. The second socket member 36 illustrated in FIG. 5A has the through hole 37a. The opening of the through hole 37a is circular. In contrast, the opening of the through hole 37a in a second socket member 36″ of Modified Embodiment 3 is a tool fitting portion 37c. The tool fitting portion 37c is provided as an engagement hole with a polygonal inner periphery. The tool fitting portion 37c can be operated by fitting another tool such as a hexagonal wrench. The nut 22 can be tightened by using another tool. The tightening torque can be controlled by using a torque wrench. The shape of the tool fitting portion 37c is not limited to a hexagonal shape, and may be a square or other polygonal shape.

### Modified Embodiment 4

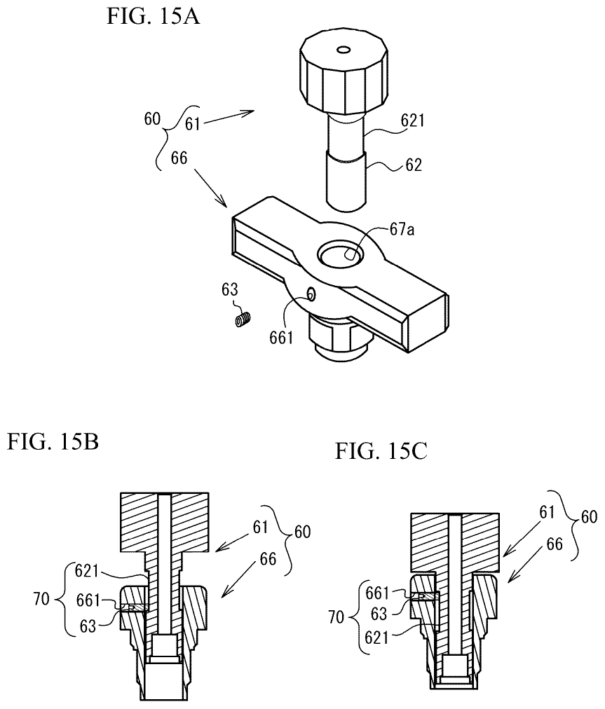

In the adjustment tool 30 of this embodiment, the first socket member 31 and the second socket member 36 are separable. In contrast, one of a first socket member 61 and a second socket member 66 included in an adjustment tool 60 illustrated in FIG. 15A to FIG. 15C can be provided with a retaining mechanism 70 to prevent the one from coming off the other. The retaining mechanism 70 includes an engagement groove 621 formed on the outer circumferential surface of a first columnar portion 62 of the first socket member 61 and a set screw 63 screwed into a screw hole 661 provided in the side wall of the second socket member 66.

The set screw 63 is provided so that its tip is positioned within the engagement groove 621 and can engage with the engagement groove 621 when the first columnar portion 62 is inserted into a through hole 67a. However, a predetermined gap is formed between the tip of the set screw 63 and the bottom surface of the engagement groove 621 so that the first socket member 61 and the second socket member 66 can rotate relative to each other. After the amount of screwing of the set screw 63 is adjusted so that the predetermined gap is maintained, the set screw 63 may be fixed with an adhesive or the like so that its position is maintained.

By providing the retaining mechanism 70, the first socket member 61 and the second socket member 66 can be handled as a single unit and will not accidentally fall off from each other, making it easier to operate the adjustment tool 60.

The set screw 63 may be changed to another member that can protrude into the engagement groove 621, such as a pin-shaped member or a small piece-shaped member, so as to be able to engage with the engagement groove 621. The screw hole 661 may also be changed as appropriate depending on the shape of the member being used.

The present invention is not limited to the specifically disclosed embodiments and variations but may include other embodiments and variations without departing from the scope of the present invention.

What is claimed is:

1. A rotary encoder that is attached to a device having a device body and a rotation portion that is provided so as to be rotatable relative to the device body, the rotary encoder comprising:
a rotor attached to the rotation portion; and
a stator attached to the device body via a position adjustment mechanism,
wherein the position adjustment mechanism includes a hollow bolt having a hollow cylindrical portion as a shaft portion and an outer peripheral screw portion on an outer peripheral surface of the shaft portion that screws into an inner peripheral screw portion provided in a mounting hole of the stator, a nut that screws into the outer peripheral screw portion, and a fixing screw that is inserted into the hollow cylindrical portion and screwed into the device body, and
wherein a diameter of the inner surface of the hollow cylindrical portion is set to a dimension that forms a gap between the inner surface and a screw portion of the fixing screw, allowing the stator, which is screwed into the hollow bolt, to move in a direction orthogonal to an axial direction of the fixing screw.

2. The rotary encoder as claimed in claim 1,
wherein an opposite side dimension of the nut is equal to or greater than an opposite side dimension of a head of the hollow bolt.

3. The rotary encoder as claimed in claim 1 further comprising:
a pressurizing mechanism for biasing the hollow bolt toward the device body.

4. The rotary encoder as claimed in claim 3,
wherein the pressurizing mechanism includes a spring member disposed between a head of the fixing screw and a head of the hollow bolt.

5. The rotary encoder as claimed in claim 4,
wherein the spring member is a spring washer through which the screw portion of the fixing screw is inserted.

6. The rotary encoder as claimed in claim 1,
wherein the position adjustment mechanism is provided in a plurality of positions along a circumferential direction of the stator.

7. The rotary encoder as claimed in claim 1,
wherein the position adjustment mechanism is disposed at equal intervals of 120° in a circumferential direction of the stator.

8. A position adjustment mechanism for adjusting a position of a position adjustment target portion with respect to a base part, the position adjustment mechanism comprising:
a hollow bolt having a hollow cylindrical portion as a shaft portion and having an outer peripheral screw portion on an outer peripheral surface of the shaft portion that screws into an inner peripheral screw portion provided in a mounting hole of the position adjustment target portion;
a nut that screws into the outer screw portion; and
a fixing screw that is inserted into the hollow cylindrical portion and screwed into the base part,
wherein a diameter of an inner surface of the hollow cylindrical portion is set to a dimension that forms a gap between inner surface and a screw portion of the fixing screw, allowing the position adjustment target portion, which is screwed into the hollow bolt, to move in a direction orthogonal to an axial direction of the fixing screw.

9. The position adjustment mechanism as claimed in claim 8,
wherein an opposite side dimension of the nut is equal to or greater than an opposite side dimension of a head of the hollow bolt.

10. The position adjustment mechanism as claimed in claim 8 further comprising:
s pressurizing mechanism for biasing the hollow bolt toward the base part.

11. The position adjustment mechanism as claimed in claim 10,
wherein the pressurizing mechanism includes a spring member disposed between a head of the fixing screw and a head of the hollow bolt.

12. The position adjustment mechanism as claimed in claim 11,
wherein the spring member is a spring washer through which the screw portion of the fixing screw is inserted.

13. An adjustment tool for adjusting a position of a position adjustment target portion with respect to a base part by operating a position adjustment mechanism including: a hollow bolt having an outer peripheral screw portion on an outer peripheral surface of a hollow cylindrical portion, the outer peripheral screw portion being screwed with an inner peripheral screw portion provided in a mounting hole of a position adjustment target portion provided so as to be position-adjustable with respect to a base part; a nut screwed with the outer peripheral screw portion; and a fixing screw inserted into the hollow cylindrical portion and screwed with the base part, the adjustment tool comprising:
a first socket member having a first columnar portion with a first fitting portion at a tip end into which a head of the hollow bolt fits; and
a second socket member having a second columnar portion into which the first columnar portion is inserted from a base end side and is arranged to be coaxially rotatable relative to the first columnar portion, and which has a second fitting portion at a tip end into which the nut fits,
wherein the first columnar portion has a through hole into which a tool for rotating the fixing screw is inserted from the base end side.

14. The adjustment tool as claimed in claim 13,
wherein the second socket member includes a handle portion extending in a direction orthogonal to an axial direction of the second columnar portion.

15. The adjustment tool as claimed in claim 13,
wherein the second socket member is provided with a tool fitting portion into which a tool other than the first socket member is fitted.

16. The adjustment tool as claimed in claim 15,
wherein the tool fitting portion is a cylindrical portion of the second socket member having a polygonal outer periphery.

17. The adjustment tool as claimed in claim 15,
wherein the tool fitting portion includes an engagement hole having an inner periphery in a polygonal shape.

18. A position adjustment method of a position adjustment target portion with respect to a base part, using an adjustment of claim 13, the method comprising:
rotating the second socket member with the nut fitted to the second fitting portion, inserting a tool for rotating the fixing screw into the through hole of the first columnar portion, loosening the fixing screw with the tool, and making the hollow bolt rotatable;
rotating a first socket member with a head of the hollow bolt fitted into the first fitting portion to adjust the distance of the position adjustment target portion relative to the base part;
moving the position adjustment target portion in a plane parallel to the base part while the fixing screw is loosened;
tightening the nut to fix the distance of the position adjustment target portion relative to the base part; and
tightening the fixing screw to fix the position adjustment target portion in a plane parallel to the base part.

19. The method as claimed in claim 18,
wherein the moving the position adjustment target portion within a plane parallel to the base part with the fixing screw loosened is performed while the hollow bolt is biased toward the base part by the pressurizing mechanism.
